(19) United States
(12) Patent Application Publication
(10) Pub. No.: US 2026/0025605 A1
(43) Pub. Date: Jan. 22, 2026

(54) REMEDIATING PREDICTED PASSIVE OPTICAL NETWORK OUTAGES

(71) Applicant: AT&T Communications Services India Private Limited, Bangalore (IN)

(72) Inventor: Mritunjay Pandey, Bangalore (IN)

(21) Appl. No.: 18/776,218

(22) Filed: Jul. 17, 2024

(51) Int. Cl. H04Q 11/00

(52) U.S. Cl. CPC H04Q 11/0067; H04Q 2011/0064; H04Q 2011/0086

(57) ABSTRACT

A method includes obtaining parameters describing settings of network elements and paths of a passive optical network (PON), obtaining a set of resource requirements for a new service that is to be run in the PON, executing a machine learning model that is trained to predict a likelihood of an outage occurring in the PON when the settings of the network elements and the paths are configured in accordance with the set of parameters and the set of resource requirements is applied to the PON, executing, in response to determining that the likelihood is greater than a threshold, the machine learning model to predict an adjustment to the settings that will bring the likelihood below the threshold when the new application is run in the PON, and sending a command to at least one of: a network element or a path to make the adjustment to the settings.

The present disclosure relates generally to fiber broadband network infrastructure, and relates more particularly to devices, non-transitory computer-readable media, and methods for remediating predicted passive optical network outages.

### BACKGROUND

Passive optical networks (PONs) are fiber optic broadband networks that utilize a type of fiber deployment in which no electrical hardware is deployed in the fiber plant. PONs are often used to carry signals over the last mile between Internet service providers (ISPs) and customers. In such a case, a PON has a point-to-multipoint topology in which the ISP uses a single device to serve many customer sites. For instance, a single optical fiber may be split into multiple fibers (e.g., through a passive splitter), and each of the multiple fibers can in turn be further split (e.g., using additional splitters) to serve multiple customer sites. The light from the ISP is divided through all of the splitters to reach all of the customer sites, and light from all of the customer sites is combined back into the single fiber.

### SUMMARY

In one example, the present disclosure describes a device, computer-readable medium, and method for remediating predicted passive optical network outages. For instance, in one example, a method for remediating predicted passive optical network outages includes obtaining a set of parameters describing settings of a plurality of network elements and a plurality of paths of a passive optical network, obtaining a set of resource requirements for a new service that is to be run in the passive optical network, executing a machine learning model that is trained to predict a likelihood of an outage occurring in the passive optical network when the settings of the plurality of network elements and the plurality of paths are configured in accordance with the set of parameters and the set of resource requirements is applied to the passive optical network, executing, in response to determining that the likelihood is greater than a threshold, the machine learning model to predict an adjustment to the settings of the plurality of network elements and the plurality of paths that will bring the likelihood below the threshold when the new application is run in the passive optical network, and sending a command to at least one of: a network element of the plurality of network elements or a path or the plurality of paths to make the adjustment to the settings.

In another example, a non-transitory computer-readable medium stores instructions which, when executed by a processing system including at least one processor, cause the processing system to perform operations. The operations include obtaining a set of parameters describing settings of a plurality of network elements and a plurality of paths of a passive optical network, obtaining a set of resource requirements for a new service that is to be run in the passive optical network, executing a machine learning model that is trained to predict a likelihood of an outage occurring in the passive optical network when the settings of the plurality of network elements and the plurality of paths are configured in accordance with the set of parameters and the set of resource requirements is applied to the passive optical network, executing, in response to determining that the likelihood is greater than a threshold, the machine learning model to predict an adjustment to the settings of the plurality of network elements and the plurality of paths that will bring the likelihood below the threshold when the new application is run in the passive optical network, and sending a command to at least one of: a network element of the plurality of network elements or a path or the plurality of paths to make the adjustment to the settings.

In another example, a system includes a processing system including at least one processor and a non-transitory computer-readable medium storing instructions which, when executed by the processing system, cause the processing system to perform operations. The operations include obtaining a set of parameters describing settings of a plurality of network elements and a plurality of paths of a passive optical network, obtaining a set of resource requirements for a new service that is to be run in the passive optical network, executing a machine learning model that is trained to predict a likelihood of an outage occurring in the passive optical network when the settings of the plurality of network elements and the plurality of paths are configured in accordance with the set of parameters and the set of resource requirements is applied to the passive optical network, executing, in response to determining that the likelihood is greater than a threshold, the machine learning model to predict an adjustment to the settings of the plurality of network elements and the plurality of paths that will bring the likelihood below the threshold when the new application is run in the passive optical network, and sending a command to at least one of: a network element of the plurality of network elements or a path or the plurality of paths to make the adjustment to the settings.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for remediating predicted passive optical network outages may operate;

FIG. 2 illustrates a flowchart of an example method for training a machine learning model to remediate predicted passive optical network outages;

FIG. 3 illustrates a flowchart of an example method for remediating predicted passive optical network outages; and

FIG. 4 illustrates a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides a system, method, and non-transitory computer readable medium for remediating predicted passive optical network (PON) outages. As discussed above, PONs are often used to carry signals over the last mile between Internet service providers (ISPs) and customers. In such a case, a PON has a point-to-multipoint topology in which the ISP uses a single device to serve many customer sites. For instance, a single optical fiber may be split into multiple fibers (e.g., through a passive splitter), and each of the multiple fibers can in turn be further split (e.g., using additional splitters) to serve multiple customer sites. The light from the ISP is divided through all of the splitters to reach all of the customer sites, and light from all of the customer sites is combined back into the single fiber.

PONs may be prone to outages (i.e., disruptions of service) caused by severed optical fibers, natural disasters or accidents, hardware malfunctions, and other causes. Signal strength in a PON may also be weakened by various factors including physical distances between elements of the PON infrastructure (e.g., optical line terminal (OLTs), optical distribution networks (ODNs), and optical network terminals (ONTs)), gain profiles of the optical fibers, absorption losses of the optical fibers, scatterings (e.g., Rayleigh scattering, Mie scattering, or the like) in the optical fibers, dispersion profiles (e.g., chromatic, polarization mode, model, or the like) of the optical fibers, and other optical fiber characteristics. Additionally, changing optical characteristics (e.g., refractive index, polarization mode dispersion, or the like)) in a PON due to the addition of high capacity channels, fiber twists, and other network topology changes may impact existing spectrum channels and/or limit an ISP's ability to launch new spectrum channels, which can further contribute to outages.

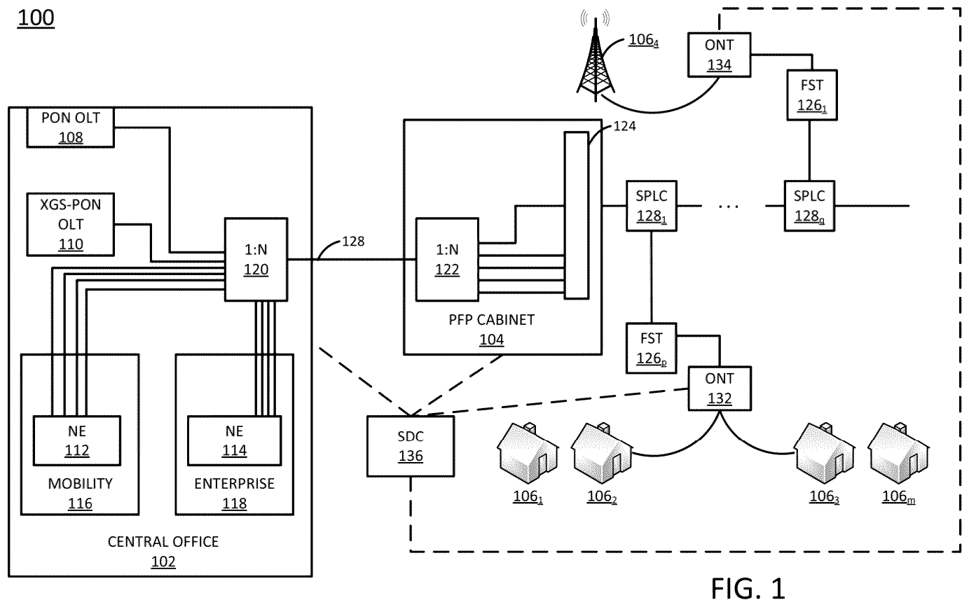

Examples of the present disclosure provide a system that learns the topology and optical characteristics of a PON and predicts, based on the needs of a specific application, whether the resources of the PON are sufficient to support the application. If the resources of the PON are not sufficient to support the application, then examples of the present disclosure may initiate adjustments to the topology and/or optical characteristics to ensure sufficient support for the application and avoid a potential network outage. These and other aspects of the present disclosure are discussed in further detail with reference to FIGS. 1-4, below.

To further aid in understanding the present disclosure, FIG. 1 illustrates an example system 100 in which examples of the present disclosure for remediating predicted passive optical network outages may operate. The system 100 may comprise at least a portion of an optical distribution network (ODN). In one example, the system 100 generally comprises a send side comprising a central office (or head end) 102 and a receive side comprising a primary flexibility point (PFP) cabinet 104 and a plurality of customer sites 106₁-106ₘ (hereinafter individually referred to as a “customer site 106” or collectively referred to as “customer sites 106”).

The central office 102 comprises a hub or centrally located point in the system 100 at which a conglomerate signal is distributed to optical nodes (e.g., in neighborhoods or premises locations). The conglomerate signal may carry voice, data, and/or video services to the customer sites 106. In one example, the central office 102 may include one or more optical line terminals (OLTs) 108 and 110. The OLTs 108 and 110 comprise the starting points of fiber optic access networks, such as a 25 G or 50 G PON or a higher speed XGS-PON. The central office 102 may further include one or more network elements (NEs) 112 and 114 supporting one or more service networks, such as a mobility network 116, an enterprise network 118, or another type of service network.

The OLTs 108 and 110, as well as the NEs 112 and 114, may all be connected (e.g., via Ethernet cables) to a first optical splitter 120. The first optical splitter 120 may be a 1: N optical splitter that is capable of receiving up to N transmission signals (e.g., from the OLTs 108 and 110 and the NEs 112 and 114) and converging the N transmission signals onto a single backbone feeder fiber 128.

The NEs 112 and 114 may output their transmission signals directly to the first optical splitter 120, i.e., without those transmission signals having to be combined into a single combined signal by a filter/multiplexer combination. The first optical splitter 120 can therefore output the conglomerate signal (comprising the transmission signals from the OLTs 108 and 110 and the NEs 112 and 114, which may be of multiple different wavelengths) via the backbone feeder fiber 128.

On the receive side, the cabinet 104 comprises an enclosure which houses a second optical splitter 122 and a distribution fiber cable termination panel 124. In one example, the second optical splitter 122 is a 1:N optical splitter that receives (via the backbone feeder fiber 128) the conglomerate signal that is output by the first optical splitter 120 in the central office 102. The second optical splitter 122 separates the single conglomerate signal into up to N individual signals of different wavelengths (e.g., one wavelength or range of wavelengths per individual signal) and delivers the up to N individual signals to the distribution fiber cable termination panel 124 for distribution to the customer sites 106.

From the distribution fiber cable termination panel 124, the up to N individual signals may be delivered to a plurality of flexible service terminals (FSTs) 126₁-126ₚ (hereinafter individually referred to as an “FST 126” or collectively referred to as “FSTs 126”) via a plurality of respective factory splices (SPLCs) 128₁-128_{q} (hereinafter individually referred to as a “splice 128” or collectively referred to as “splices 128”), also sometimes referred to as “tethers”).

In one example, each FST 126 is associated with one or more customer sites 106, such as homes, offices, cellular base stations (e.g., eNodeBs in long term evolution networks or gNodeBs in fifth generation networks) and other network termination equipment (NTE), radio nodes and sensors (e.g., picoradio nodes), and other customer sites. Thus, each signal of the up to N individual signals may be routed via the distribution fiber cable termination panel 124 to the FST 126 associated with the customer site 106 that is the destination for the signal. Each of the up to N individual signals may be presented via one or more native service interfaces to users at the customer sites 106. These services may include voice (e.g., plain old telephone service, voice over Internet Protocol, etc.), data (e.g., Ethernet, V.35, etc.), video, and/or telemetry services.

In fiber-to-the-premises (FTTP) connections, the fiber optic cable runs all the way into the customer sites 106 and is connected (e.g., via fiber drops) directly to an optical network terminal (ONT) 132 or 134 (also sometimes referred to as an optical network unit or ONU) which converts fiber signals (i.e., pulses of light) into data that can be rendered by the systems or user endpoint devices at the customer site 106, such as personal computers, set top boxes, smart televisions, and the like. FIG. 1 illustrates one ONT 132 serving the customer sites 106₁-106ₘ and one ONT 134 serving the customer site 106₄.

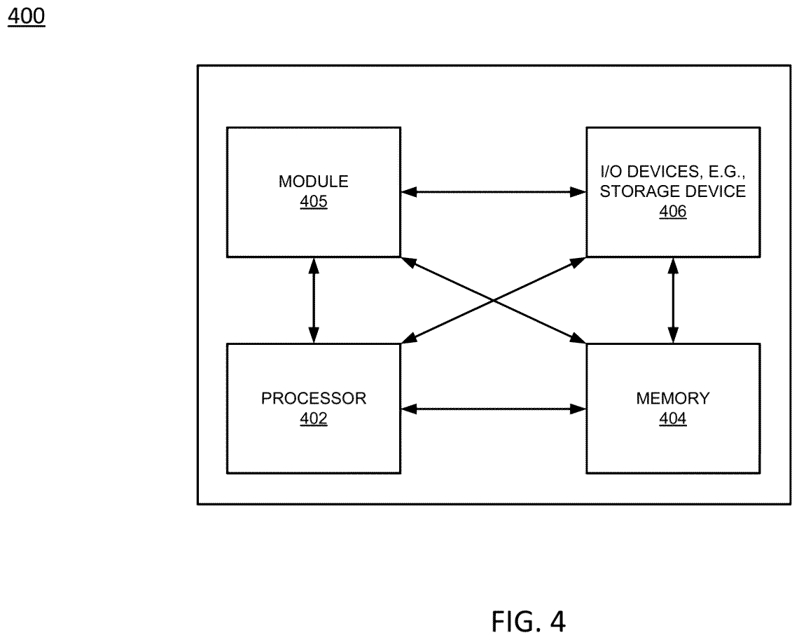

According to examples of the present disclosure, the system 100 may further include a software defined controller (SDC) 136 that is connected to the central office 102, the PFP cabinet 104, the ONT 132, and the ONT 134 and configured to perform operations for remediating predicted passive optical network outages. In one example, the SDC 136 may be configured in a manner similar to the computing device 400 illustrated in FIG. 4. Thus, the SDC 136 may include one or more components such as memory, non-transitory computer-readable media, and the like.

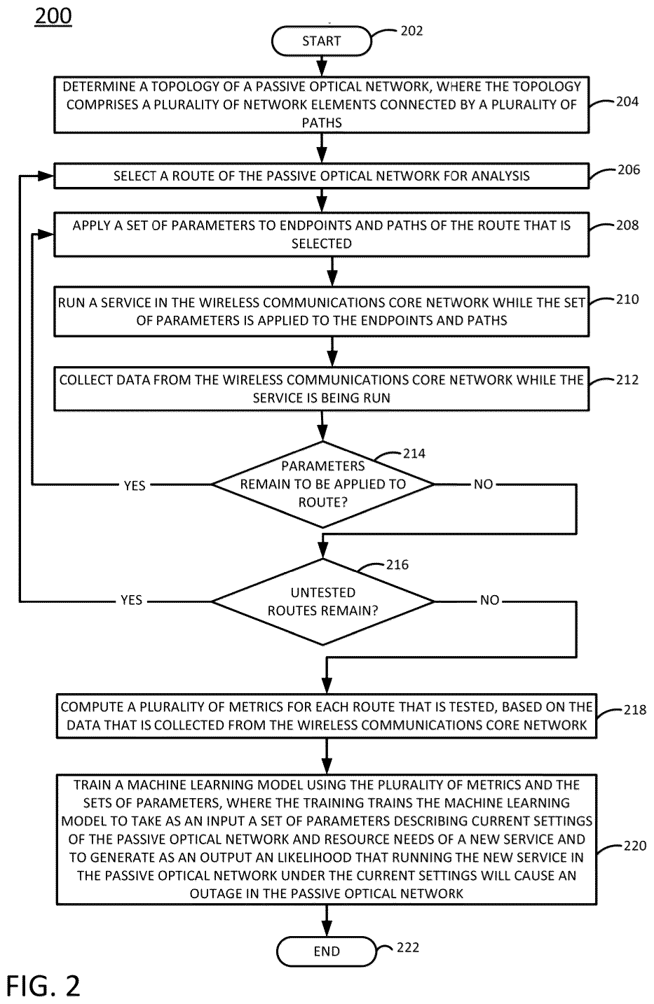

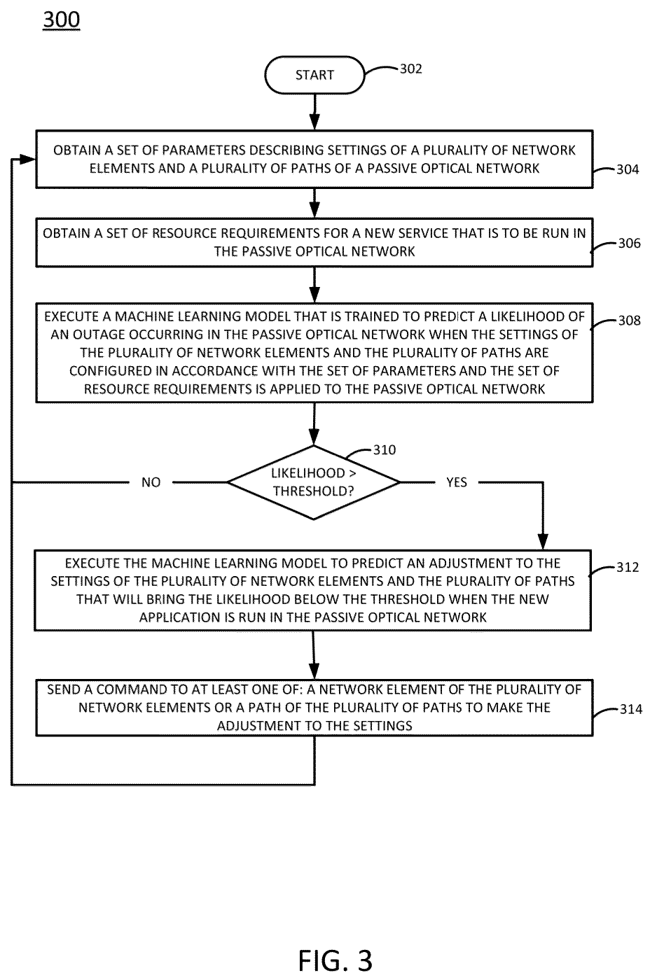

In practice, the SDC 136 may collect data from the central office 102, the PFP cabinet 104, the ONT 132, and/or the ONT 134 related to the topology and optical characteristics of the system 100. The collected data may be used to train a machine learning model to predict when the deployment or execution of an application in the system 100 may cause a system outage (e.g., due to insufficient resources) and to generate a recommended adjustment to the topology and/or optical characteristics of the system 100 that is likely to support the deployment or execution of the application without causing a system outage. One example of a method for training a machine learning model to predict system outages and generate recommended adjustments or remediation is discussed in further detail with respect to FIG. 2. One example of a method for predicting when deployment or execution of an application will cause a system outage and for generating recommended adjustments or remediation is discussed in further detail with respect to FIG. 3.

It should be noted that the system 100 has been simplified. Thus, those skilled in the art will realize that the system 100 may be implemented in a different form than that which is illustrated in FIG. 1, or may be expanded by including additional endpoint devices, access networks, network elements, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

To further aid in understanding the present disclosure, FIG. 2 illustrates a flowchart of an example method 200 for training a machine learning model to remediate predicted passive optical network outages. In one example, the method 200 may be performed by the SDC 136 of FIG. 1. However, in other examples, the method 200 may be performed by another device, such as the computing system 400 of FIG. 4, discussed in further detail below. For the sake of discussion, the method 200 is described below as being performed by a processing system (where the processing system may comprise a component of a software defined controller, the computing system 400, or another device).

The method 200 begins in step 202. In step 204, the processing system may determine a topology of a passive optical network, where the topology comprises a plurality of network elements connected by a plurality of paths.

In one example, the passive optical network may be part of a larger wireless communications core network, such as a Fifth Generation (5G) core network. The plurality of network elements may include multiplexers, demultiplexers, optical line terminals, optical distribution networks, optical network terminals, flexible service terminals, network splices, and the like, as well as wired and wireless paths between the network elements. In one example, wired paths may include optical fiber connections. The processing system may determine the physical locations of these network elements and paths (including the distances between the network elements and the physical lengths of the paths), as well as settings, capabilities, and features of the network elements and paths.

In one example, the capabilities of the network elements that are determined by the processing system may include at least one of: a supported data rate, a supported modulation format, a supported forward error correction technique (e.g., standard, enhanced, adaptive, etc.), or a supported data type (e.g., Ethernet, optical transport network, fiber channel, etc.).

In one example, the capabilities of the paths that are determined by the processing system may include the frequencies of any spectrum channels that are part of those paths.

In step 206, the processing system may select a route of the passive optical network for analysis. In one example, a route may comprise a series of one or more wired and/or wireless paths that connect endpoints of the passive optical network, where the endpoints may include a first network element and a second network element. In some examples, a route may include any intermediate network elements that signals must traverse in order to travel from the first network element to the second network element, or vice versa. Thus, a route may include at least two network elements of the plurality of network elements and at least one path of the plurality of paths. Wired paths of the route may include optical fiber connections, and any optical fiber connection may support a plurality of spectrum channels. The plurality of spectrum channels may include multiple spectrum channels of different frequencies.

In step 208, the processing system may apply a set of parameters to endpoints and paths of the route that are selected. As discussed above, the endpoints of the route that are selected may include network elements of the plurality of network elements and paths of the plurality of paths. In one example, the parameters that are applied to the endpoints and paths may comprise specific settings or values for any of the capabilities that are determined in step 204. For instance, the processing system may send a command to each of the endpoints and paths in the route, where a command instructs an endpoint to apply specific settings or values for data rate, modulation format, forward error correction technique, and/or data type. A command sent to a path may instruct the path to apply specific settings or values for the frequencies of any spectrum channels that are part of the path. The specific settings or values may be predefined for a particular service (e.g., software application) that is to run in the passive optical network. For instance, a first service may be associated with a first set of settings or values for the capabilities, while a second service may be associated with a second, different set of settings or values for the same capabilities. Thus, in one example, if a service is specified, the processing system may select (e.g., by looking up in a lookup table or similar data structure) a predefined set of settings or values that is associated with the specified service.

In step 210, the processing system may run a service in the wireless communications core network while the set of parameters is applied to the endpoints and paths. In one example, the service may be a service that is associated (e.g., in a lookup table or similar data structure) with the set of parameters, as discussed above. For instance, the service may comprise a mobile data service, a voice calling service, a content distribution (e.g., media streaming) service, or another type of service.

In step 212, the processing system may collect data from the passive optical network while the service is being run. In one example, the data that is collected in step 212 may include metrics that indicate the signal strengths of the one or more paths in the route that is selected in step 206. For instance, the data that is collected in step 212 may include the bandwidth of one or more spectrum channels of the one or more paths, the latency of the one or more spectrum channels, a signal drop rate of the one or more spectrum channels, or another metric.

In step 214, the processing system may determine whether any sets of parameters remain to be applied to the route that is selected. For instance, as discussed above, different sets of parameters may be associated with different services that may run in the passive optical network. Thus, an operator of the passive optical network may wish to test how different services may place different demands (e.g., in terms of network traffic) on the passive optical network. In further examples, a service may be associated with multiple different sets of parameters, such as where the service may be a subscription service that offered multiple different tiers of service at different price points. Thus, the operator of the passive optical network may wish to test how the different tiers of service for the same service may place different demands on the passive optical network.

In one example, prior to the method 200 being initiated, the operator of the passive optical network may define a list of sets of parameters that are to be tested in accordance with the method 200, and the processing system may work its way through the list, one set of parameters at a time (e.g., iterating through steps of the method 200 as necessary).

If the processing system concludes in step 214 that there are sets of parameters that remain to be applied to the route that is selected, then the method 200 may return to step 208 and select a new set of parameters to apply to the route that is selected. Steps 210-214 may then be repeated as discussed above.

If, however, the processing system concludes in step 214 that there are no sets of parameters that remain to be applied to the route that is selected, then the method 200 may proceed to step 216. In step 216, the processing system may determine whether any untested routes remain.

As discussed above, the passive optical network may comprise a plurality of routes, and each route may include one or more paths (e.g., wired and/or wireless connections), such that there may be multiple possible ways to connect any given pair of network elements. In one example, the processing system may test every route of the passive optical network when performing the method 200 (iterating through steps of the method 200 as necessary), so that the impacts of various services and parameter configurations on the entire passive optical network can be determined.

If the processing system concludes in step 216 that there are untested routes that remain to be tested, then the method 200 may return to step 206 and select a new route for analysis. Steps 208-216 may then be repeated as discussed above.

If, however, the processing system concludes in step 216 that there are no untested routes that remain to be tested, then the method 200 may proceed to step 218. In step 218, the processing system may compute a plurality of metrics for each route that was tested in steps 206-216, based on the data that is collected in step 212.

In one example, the plurality of metrics may include at least one of: spectral efficiency, asymptotic power efficiency, average energy (e.g., per bit transferred along route), signal attenuation (e.g., per unit length of route), simulated Brillouin scattering (SBS), simulated Raman scattering (SRS), and Rayleigh scattering.

In one example, the spectral efficiency (SE) of a route may be calculated for all combinations of modulation formats and data rate on the route. In one example, SE may be calculated, for any combination of modulation format and data rate, as:

$$SE = {Log}_{2} ( M ) \div ( N / 2 ) \qquad ( EQN . 1 )$$

where M represents a number of symbols of the modulation format, and N represents the dimensionality of the modulation format.

In one example, the asymptotic power efficiency (APE) of a route may be calculated as:

$$APE = γ = \frac{{d}_{min}^{2}}{4 {E}_{b}} = \frac{{d}_{min}^{2} {log}_{2} ( M )}{4 {E}_{s}} \qquad ( EQN . 2 )$$

where d represents the diameter of the optical fiber core of the route (e.g., measured in micrometers), E_{b} represents the energy per bit traversing the route, and Eₛ represents the average symbol rate of the modulation format and may be calculated as:

$${E}_{s} = \frac{1}{M} {\sum }_{k = 1}^{M} {‖ {c}_{k} ‖}^{2} \qquad ( EQN . 3 )$$

where cₖ represents the kth symbol rate. The value of cₖ may vary from k−1 to M.

In one example, the average energy A E_{b} may be calculated, per bit of data transferred along the route, as:

$${AE}_{b} = {E}_{s} / {log}_{2} ( M ) \qquad ( EQN . 4 )$$

In one example, the signal attenuation per unit length of a route α_{dB} of a route may be calculated (e.g., in decibels per kilometer) as:

$${α}_{dB} * L = 10 {log}_{10} \frac{Pi}{Po} \qquad ( EQN . 5 )$$

where L is the optical length of the route, Pi is the launch power of the route, and Po is the received power of the route.

In one example, the simulated Brillouin scattering PB of a route may be calculated in watts as:

$${P}_{B} = 4.4 \times {10}^{- 3} {d}^{2} {λ}^{2} {α}_{dB} v \qquad ( EQN . 6 )$$

where λ is the operating wavelength of the optical fiber core of the route (e.g., measured in micrometers) and v is the bandwidth of an injection laser of the route.

In one example, the simulated Raman scattering PR of a route may be calculated as:

$${P}_{R} = 5.9 \times {10}^{- 2} {d}^{2} λ {α}_{dB} \qquad ( EQN . 7 )$$

In one example, setting of SBS and SRS thresholds may help to control the launch powers of spectrum channels to minimize SBS and SRS.

In one example, Rayleigh scattering (for which the coefficient is Γ_{R}) may be calculated according to:

$${Γ}_{R} = \frac{8 {π}^{3}}{3 {λ}^{4}} {n}^{8} p 2 {β}_{C} {KT}_{F} \qquad ( EQN . 8 )$$

where n represents the refractive index of the optical fiber core of a route, p represents an average photo-elastic coefficient, β_{C} represents the isothermal compressibility of the optical fiber core at a fictive temperature TF, and K represents Boltzmann's constant. Thus, for an optical fiber core having a constant refractive index, all parameters of EQN. 8 will likewise be constant, and the Rayleigh scattering will depend completely on the wavelength of the light passing through the optical fiber core.

In step 220, the processing system may train a machine learning model using the plurality of metrics and the sets of parameters, where the training trains the machine learning model to take as an input a set of parameters describing current settings of the passive optical network and resource needs of a new service and to generate as an output a likelihood that running the new service in the passive optical network under the current settings will cause an outage in the passive optical network.

In one example, the machine learning model may be based on any one or more of: a decision tree, a random forest algorithm, a naïve Bayes algorithm, a support vector machine, a gradient boost algorithm, a neural network, a nearest neighbor algorithm, a linear regression algorithm, or another type of machine learning technique.

Once trained, the machine learning model will predict, for an input combination of parameters describing the current settings of the passive optical network (including settings for optical parameters of the network elements and paths) and describing the resource needs of a new service, a likelihood that running the new service in the passive optical network will cause an outage.

In a further example, the machine learning model may further predict a remediating action that can be taken to prevent an outage that is predicted as having a likelihood that is greater than a threshold. For instance, if the predicted likelihood f an outage is greater than fifty percent (e.g., more likely than not), then the machine learning model may be trained to further generate a recommended remediating action that is estimated to lower the likelihood to below the threshold. In one example, the recommended remediating action may be an adjustment to an optical parameter setting of a network element or path of the passive optical network. For instance, the recommended remediating action may involve adjusting a frequency of a spectrum channel for carrying data related to the new service on a path of the passive optical network to an optimal frequency, or launching a new spectrum channel with an optimal frequency for carrying data related to the new service. In one example, an optimal frequency may be one that is sufficient to minimize both signal drop on the path and wastage of resources on the path. For instance, an optimal frequency may ensure that signal drop does not exceed a threshold rate, but also seek to ensure that no more than a threshold amount of resources associated with the frequency go unused over a defined period of time.

The method 200 may end in step 222. However, in some examples, the method 200 may be repeated periodically, or in response to a network event such as a change in the topology of the passive optical network (e.g., addition or removal of a network element or path, hardware or software updates that alter the capabilities of network elements or paths, or the like) or a change in the services that run in the passive optical network (e.g., deployment of a new service or a new feature of an existing service).

FIG. 3 illustrates a flowchart of an example method 300 for remediating predicted passive optical network outages. In one example, the method 300 may be performed by the SDC 136 of FIG. 1. However, in other examples, the method 300 may be performed by another device, such as the computing system 400 of FIG. 4, discussed in further detail below. For the sake of discussion, the method 300 is described below as being performed by a processing system (where the processing system may comprise a component of a software defined controller, the computing system 400, or another device).

The method 300 begins in step 302. In step 304, the processing system may obtain a set of parameters describing settings of a plurality of network elements and a plurality of paths of a passive optical network.

In one example, the topology of the passive optical network may include a plurality of network elements (e.g., multiplexers, demultiplexers, optical line terminals, optical distribution networks, optical network units, flexible service terminals, factory splices, and the like), as well as wired and wireless paths between the network elements. In one example, wired paths may include optical fiber connections. The physical locations of these network elements and paths (including the distances between the network elements and the physical lengths of the paths), as well as settings, capabilities, and features of the network elements and paths, may be known to the processing system.

In one example, the parameters may identify specific values for the settings of the plurality of network elements and plurality of paths. In one example, the settings of the network elements may relate to at least one of: a supported data rate, a supported modulation format, a supported forward error correction technique (e.g., standard, enhanced, adaptive, etc.), or a supported data type (e.g., Ethernet, optical transport network, fiber channel, etc.). In one example, the settings of the paths may relate to the frequencies of any spectrum channels that are part of those paths.

In step 306, the processing system may obtain a set of resource requirements for a new service that is to be run in the passive optical network. In one example, the resource requirements may specify threshold performance metrics (e.g., bandwidth, latency, signal drop rate, or the like) that the passive optical must satisfy in order to support optimal operation of the new service.

In step 308, the processing system may execute a machine learning model that is trained to predict a likelihood of an outage occurring in the passive optical network when the settings of the plurality of network elements and the plurality of paths are configured in accordance with the set of parameters and the set of resource requirements is applied to the passive optical network.

As discussed above, the machine learning model may be based on any one or more of: a decision tree, a random forest algorithm, a naïve Bayes algorithm, a support vector machine, a gradient boost algorithm, a neural network, a nearest neighbor algorithm, a linear regression algorithm, or another type of machine learning technique.

In one example, the machine learning model may predict whether the passive optical network is likely to experience an outage, given the set of parameters describing the settings of the plurality of network elements and the plurality of paths and the resource requirements for the new service. In other words, the likelihood may indicate how well the current configuration of the passive optical network can support the new service, in addition to any services already supported by the passive optical network.

In step 310, the processing system may determine whether the likelihood is greater than a threshold. In one example, the threshold is predefined and configurable. For instance, the threshold may be set by an operator of the passive optical network and may be determined based on a minimum quality of service that the operator is contracted to provide to customers. In one example, a likelihood that is greater than the threshold may indicate that the passive optical network is more likely than not to experience an outage if the new service is run with the current configuration of the passive optical network (i.e., as characterized by the settings of the plurality of network elements and the plurality of paths). Conversely, a likelihood that is at or below the threshold may indicate that the passive optical is more likely than not to operate continuously (e.g., without an outage) if the new service is run with the current configuration of the passive optical network.

If the processing system concludes in step 310 that the likelihood is not greater than the threshold, then the method 300 may return to step 304, and the processing system may continue as described above to obtain parameters describing the settings of the plurality of network elements and the plurality of paths. Thus, the processing system may continuously monitor the topology of the passive optical network (which may change over time as network elements and paths are added, removed, rerouted, or the like) and the services running in the passive optical network to screen for conditions that may lead to outages.

If, however, the processing system concludes in step 310 that the likelihood is greater than the threshold, then the method 300 may proceed to step 312. In step 312, the processing system may execute the machine learning model to predict an adjustment to the settings of the plurality of network elements and the plurality of paths that will bring the likelihood below the threshold when the new application is run in the passive optical network.

In one example, the adjustment may comprise a change to the settings of at least one network element and/or at least one path of the passive optical network. In one example, a change to the settings of a network element may include a change to at least one of: a supported data rate, a supported modulation format, a supported forward error correction technique (e.g., standard, enhanced, adaptive, etc.), or a supported data type (e.g., Ethernet, optical transport network, fiber channel, etc.).

In one example, a change to the settings of a path may include a change to at least one of: the frequency of a spectrum channel that is part of the path. In a further example, the change to the settings of the path may include the launch of a new spectrum channel that is configured to support an optimal frequency for supporting the new service. In one example, an optimal frequency may be one that is sufficient to minimize both signal drop when carrying data relating to the new service and wastage of resources on the path. For instance, an optimal frequency may ensure that signal drop does not exceed a threshold rate, but also seek to ensure that no more than a threshold amount of resources associated with the frequency go unused over a defined period of time.

In step 314, the processing system may send a command to at least one of: a network element of the plurality of network elements or a path or the plurality of paths to make the adjustment to the settings. In one example, the command may be encoded in one or more data packets that may be transmitted from the processing system to the network element and/or path via a wired and/or wireless network connection.

The method 300 may then return to step 304, and the processing system may continue as described above to obtain parameters describing the settings of the plurality of network elements and the plurality of paths. Thus, the method 300 may be repeated for changes to the topology of the passive optical network, changing resources demands of existing services supported by the passive optical network, and/or the resource demands of new services to be supported by the passive optical network.

In further examples, the processing system may learn, through execution of the method 300 over time, when the demands (e.g., in terms of network traffic or other data exchanged) on a spectrum channel carrying data associated with a particular service tend to be higher, and when the demands tend to be lower. For instance, the demands may be greater during certain times of the day, or during certain events, and lower during other times of the day. Thus, over time, the processing system may learn to predict when the demands on the spectrum channel may increase or decrease at some future time, and may proactively identify a new spectrum channel that is better optimized to meet the change in demands. The processing system may send commands to network elements and/or paths of the passive optical network to terminate use of an existing spectrum channel and reestablish a connection through the new spectrum channel (potentially at a specified time). For instance, the change from the existing spectrum channel to the new spectrum channel may be scheduled to occur during a pre-scheduled maintenance window for the passive optical network.

Although not expressly specified above, one or more steps of the method 200 or the method 300 may include a storing, displaying, and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 or FIG. 3 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the examples of the present disclosure.

FIG. 4 depicts a high-level block diagram of a computing device specifically programmed to perform the functions described herein. For example, any one or more components or devices illustrated in FIG. 1 or described in connection with the method 200 or the method 300 may be implemented as the system 400. For instance, the SDC 136 of FIG. 1 could be implemented as illustrated in FIG. 4.

As depicted in FIG. 4, the system 400 comprises a hardware processor element 402, a memory 404, a module 405 for remediating predicted passive optical network outages, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for remediating predicted passive optical network outages may include circuitry and/or logic for performing special purpose functions relating to learning the topology and optical characteristics of a passive optical network and predicting when running a new service would be likely to cause an outage in the passive optical network. The input/output devices 406 may include, for example, storage devices (including but not limited to, a tape drive, a floppy drive, a hard disk drive or a compact disk drive), a receiver, a transmitter, a transceiver, an electrical interface, an optical interface, a fiber optic communications line, an output port, or a user input device (such as a keyboard, a keypad, a mouse, and the like).

Although only one processor element is shown, it should be noted that the computer may employ a plurality of processor elements. Furthermore, although only one specific-purpose computer is shown in the Figure, if the method(s) as discussed above is implemented in a distributed or parallel manner for a particular illustrative example, i.e., the steps of the above method(s) or the entire method(s) are implemented across multiple or parallel specific-purpose computers, then the specific-purpose computer of this Figure is intended to represent each of those multiple specific-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for remediating predicted passive optical network outages (e.g., a software program comprising computer-executable instructions) can be loaded into memory 404 and executed by hardware processor element 402 to implement the steps, functions or operations as discussed above in connection with the example method 200 or example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for remediating predicted passive optical network outages (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
obtaining, by a processing system including at least one processor, a set of parameters describing settings of a plurality of network elements and a plurality of paths of a passive optical network;
obtaining, by the processing system, a set of resource requirements for a new service that is to be run in the passive optical network;
executing, by the processing system, a machine learning model that is trained to predict a likelihood of an outage occurring in the passive optical network when the settings of the plurality of network elements and the plurality of paths are configured in accordance with the set of parameters and the set of resource requirements is applied to the passive optical network;
executing, by the processing system in response to determining that the likelihood is greater than a threshold, the machine learning model to predict an adjustment to the settings of the plurality of network elements and the plurality of paths that will bring the likelihood below the threshold when the new application is run in the passive optical network; and
sending, by the processing system, a command to at least one of: a network element of the plurality of network elements or a path or the plurality of paths to make the adjustment to the settings.

2. The method of claim 1, wherein the plurality of network elements comprises at least one of: a multiplexer, a demultiplexer, an optical line terminal, an optical distribution network, an optical network terminal, a flexible service terminal, or a factory splice.

3. The method of claim 2, wherein the processing system is part of a software defined controller of the passive optical network, and wherein the software defined controller is connected to the plurality of network elements.

4. The method of claim 1, wherein the plurality of paths comprises a plurality of optical fiber connections.

5. The method of claim 1, wherein a subset of the settings associated with the plurality of network elements comprises settings for at least one of: a supported data rate, a supported modulation format, a supported forward error correction technique, or a supported data type.

6. The method of claim 5, wherein the adjustment comprises a change to at least one of: the supported data rate, the supported modulation format, the supported forward error correction technique, or the supported data type.

7. The method of claim 1, wherein a subset of the settings associated with the plurality of paths comprises a frequency of a spectrum channel that is part of a path of the plurality of paths.

8. The method of claim 7, wherein the adjustment comprises a change to the frequency of the spectrum channel.

9. The method of claim 7, wherein the adjustment comprises a launch of a new spectrum channel on the path of the plurality of paths, wherein the new spectrum channel is configured to support a frequency that is determined for the new service.

10. The method of claim 9, wherein the frequency that is determined is optimized to ensure that signal drop on the new spectrum channel does not exceed a threshold rate while no more than a threshold amount of resources associated with the frequency that is determined go unused over a defined period of time.

11. The method of claim 1, wherein the set of resource requirements specified at least one of: a threshold bandwidth, a threshold latency, or a threshold signal drop rate.

12. The method of claim 1, wherein the machine learning model is based on at least one of: a decision tree, a random forest algorithm, a naïve Bayes algorithm, a support vector machine, a gradient boost algorithm, a neural network, a nearest neighbor algorithm, or a linear regression algorithm.

13. The method of claim 1, wherein the threshold is configured by an operator of the passive optical network.

14. The method of claim 13, wherein the threshold is configured based on a minimum quality of service that the operator of the passive optical network is contracted to provide to customers of the passive optical network.

15. The method of claim 1, wherein the passive optical network is part of a fifth generation core network.

16. A non-transitory computer-readable medium storing instructions which, when executed by a processing system including at least one processor, cause the processing system to perform operations, the operations comprising:
obtaining a set of parameters describing settings of a plurality of network elements and a plurality of paths of a passive optical network;
obtaining a set of resource requirements for a new service that is to be run in the passive optical network;
executing a machine learning model that is trained to predict a likelihood of an outage occurring in the passive optical network when the settings of the plurality of network elements and the plurality of paths are configured in accordance with the set of parameters and the set of resource requirements is applied to the passive optical network;
executing, in response to determining that the likelihood is greater than a threshold, the machine learning model to predict an adjustment to the settings of the plurality of network elements and the plurality of paths that will bring the likelihood below the threshold when the new application is run in the passive optical network; and
sending a command to at least one of: a network element of the plurality of network elements or a path or the plurality of paths to make the adjustment to the settings.

17. The non-transitory computer-readable medium of claim 16, wherein the processing system is part of a software defined controller of the passive optical network, and wherein the software defined controller is connected to the plurality of network elements.

18. The non-transitory computer-readable medium of claim 16, wherein the adjustment comprises a launch of a new spectrum channel on a path of the plurality of paths, wherein the new spectrum channel is configured to support a frequency that is determined for the new service.

19. The non-transitory computer-readable medium of claim 18, wherein the frequency that is determined is optimized to ensure that signal drop on the new spectrum channel does not exceed a threshold rate while no more than a threshold amount of resources associated with the frequency that is determined go unused over a defined period of time.

20. An apparatus comprising:
a processor; and
a non-transitory computer-readable medium storing instructions which, when executed by the processing system, cause the processing system to perform operations comprising:
obtaining a set of parameters describing settings of a plurality of network elements and a plurality of paths of a passive optical network;
obtaining a set of resource requirements for a new service that is to be run in the passive optical network;
executing a machine learning model that is trained to predict a likelihood of an outage occurring in the passive optical network when the settings of the plurality of network elements and the plurality of paths are configured in accordance with the set of parameters and the set of resource requirements is applied to the passive optical network;
executing, in response to determining that the likelihood is greater than a threshold, the machine learning model to predict an adjustment to the settings of the plurality of network elements and the plurality of paths that will bring the likelihood below the threshold when the new application is run in the passive optical network; and
sending a command to at least one of: a network element of the plurality of network elements or a path or the plurality of paths to make the adjustment to the settings.
